(19) United States
(12) Patent Application Publication
(10) Pub. No.: US 2010/0224137 A1
(43) Pub. Date: Sep. 9, 2010

(54) POP-UP ANIMAL PLAY AREA

(76) Inventors: Sharon K. Pugh, Gardner, NC (US); E. J. Asbury, III, Marietta, GA (US)

Correspondence Address: E.J. ASBURY III, LLC, 1265 Lake Colony Dr., Marietta, GA, 30068, US

(21) Appl. No.: 12/630,837

(22) Filed: Dec. 3, 2009

Related U.S. Application Data
(60) Provisional application No. 61/193,479, filed on Dec. 3, 2008.

(51) Int. Cl. A01K 1/02

(52) U.S. Cl. 119/513

(57) ABSTRACT

A pop-up animal play area for a small animals or pets, such as a gerbil, hamster, rat, guinea pig, ferret, or the like. The enclosure provides an easily set-up and stored animal play enclosure. The enclosure has a sidewall with an overhanging lip or awning which precludes escape of the pets out of the device. The enclosure is built from fabric panels over a spring steel support assembly. The enclosure can be readily stored by compressing the spring support structure into a flat, thin ring assembly. Moreover, the enclosure structure may be further collapsed by twisting and coiling the assembly to form a smaller diameter package.

### CROSS-REFERENCE TO RELATED APPLICATION

This application claims the benefit of U.S. Provisional Application Ser. No. 61/193,479, filed on Dec. 3, 2008, the entirety of which is hereby incorporated herein by reference.

### BACKGROUND OF THE INVENTION

1. Field of the Invention

The present invention generally relates to apparatuses and fixtures for animal play areas. More particularly, the present invention relates to an easily set-up and stored animal play area for small pets.

2. Description of the Related Art

Many small animals can make enjoyable pets within the home. However unlike dogs and cats, not all pets may be given free roam of the house. Small animals like gerbils, hamsters, rats, guinea pigs, ferrets, and the like are typically kept in an enclosure or pen. The pens take many forms, but typically provide a feeding area and living quarters for the animal. While they permit viewing the animals, such pens do not allow ready access by the pet owners or their children to play with and interact with the animals.

Many pet owners seek to provide an area for exercise of their pets and some seek to allow the pet to be free from the caged environment. When the animal is removed from the pen, it must be supervised or be within a confined area. Some pet owners do not allow the pets to be out of their cage for fear of injury, or even death, to a small animal that roams at will. There is also the risk the animal will quickly run off through any small cubbyhole when the pet owners is distracted, taking up residence in the space available and possibly eventually escaping outdoors.

Many animal play enclosures have been used to restrict the pets movement, while providing access to the animal. Simple cardboard boxes are sometimes used, but the pet may easily climb out a straight walled box. With reference to the figures in which like numerals represent like elements throughout, FIG. 1 is a side perspective view of a commonly available pet play area 100. The play area is formed from a plurality of side plates 110. The side plates 110 typically snap or are pinned at the edges to form a complete loop or ring. The assembled side plates 110 are then placed on a horizontal surface 130 such as a floor or tabletop. The pet 120 is then placed in and allow too play within the enclosure 100. The relatively short walls of the enclosure allow easy access and viewing of the pet 120. Unfortunately, the short side walls may also allow a determined pet 120 to climb up and out of the enclosure. As this type of enclosure has no base, the pet may also burrow under the side plates 110 to escape. Moreover, the floor, carpeting, or tabletop upon which the enclosure 100 is placed is not protected from the pet's droppings, urine, dander, or claws.

As depicted in FIG. 2, in the prior art the side plates 110 are typically pinned 140 or snapped together at the edges to form a hinge joint. Multiple side plates assembled in this fashion then form a loop to make up the enclosure 100. Typical play area enclosures may use 8 or more side plates. To unpack the enclosure from a storage container and assemble the structure is time intensive. Each side plates 110 is typically disassembled from the adjacent plates to allow packaging and storage of the enclosure within a small space. Upon reassembly and set-up each joint within the play area enclosure 110 must be remade. The assembly, disassembly, and storage requirements of the prior art enclosures discourage their use and may adversely effect the overall enjoyment of the pet.

According, it would be advantageous to provide a rapidly set-up animal play enclosure for small pets. The enclosure would have sidewalls which would preclude climbing and escape by the pets but which would allow ready viewing and interaction with the animal. Such an enclosure would also incorporate a bottom to protect the surfaces of the home. The enclosure would present a pleasing design and color for both the pet and the homeowner. Finally, the enclosure could be readily cleaned and stored in a compact space. It is to such an animal play area apparatus and method that the present invention is directed.

### SUMMARY OF THE INVENTION

The disadvantages of the prior art are overcome by the present invention which, in one aspect, is a pet play enclosure for use with small pets. The play are includes a textile side wall, and a spring support structure. The textile side wall forms a cylinder having an upper edge and an opposing base edge. The spring support structure comprising a spring element, the spring element configured to urge the textile side wall into a taught and expanded position. The enclosure is configured to move from a first compressed position to a second expanded position upon the urging of the spring element.

In another aspect, the pet play enclosure may have a cylindrical textile awning, the textile awning having an awning bottom edge and an awning top edge. The bottom edge of the textile awning is affixed to the upper edge of the textile side wall. The spring support structure includes a spring element configured to urge the textile awning into a taught and expanded position. The textile awning is thus configured to move from a first compressed position to a second expanded position upon the urging of the spring element. The cylindrical textile awning may have a tapered diameter such that the diameter at the textile awning upper edge is less than the diameter at the textile awning lower edge.

In another aspect of the present invention, the spring element of the spring support structure has a spring spar in the form of a coil spring. The spring spar is constrained within pockets sewn into the textile side walls and is constrained from fully expanding by the textile sidewall.

In another aspect of the present invention, the spring element of the spring support structure comprises a plurality of spring spars spaced about the periphery of the textile side wall. The plurality of spring spars are constrained within pockets sewn into the textile side walls and are constrained from fully expanding by the textile sidewall.

In another aspect of the present invention, the spring element of the spring support structure comprises at least one spring spar in the form of a tapered coil spring. The at least one spring spar is constrained within pockets sewn into the textile awning and is constrained from fully expanding by the textile awning.

In other alternative aspects of the present invention, the enclosure includes a textile bottom affixed across the base edge of the textile side wall. The textile awning is made from a polyvinylchloride coated textile. The textile bottom is made from a urethane coated polyester.

In yet another alternative aspect of the present invention, the enclosure may be held in the first compressed position by a restraint for shipping and storage. The enclosure will pop-up to the second expanded position upon release of the restraint. The enclosure may be held in a first compressed position by a restraint and is configured to be twisted and coiled into a third collapsed position from the first compressed position. The enclosure may be held in the third collapsed position for shipping and storage by the storage packaging. The enclosure will return to the first compressed position upon twisting of the coils open. The enclosure will then pop-up to the second expanded position upon release of the restraint.

In another alternative aspect, the present invention provides a method of rapidly assembling or setting-up a pet play enclosure. The pet play enclosure includes a textile side wall, a textile bottom, and a spring support structure. The textile side wall forms a cylinder having an upper edge and an opposing base edge. The enclosure including a cylindrical textile awning having a bottom edge and a top edge and having a tapered diameter such that the diameter at the textile awning upper edge is less than the diameter at the textile awning lower edge. The bottom edge of the textile awning is affixed to the upper edge of the textile side wall. The spring support structure includes a spring element, the spring element configured to urge the textile side wall and textile awning from a first compressed position to a second expanded position. The enclosure is first held in a compressed position by a restraint for shipping and storage. The set-up or assembly method includes the release of the restraint, wherein the enclosure will pop-up to the second expanded position and be ready for use.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE DRAWINGS

FIG. 1 is a side-perspective view of a prior art pet play area formed by a plurality of side panels.

FIG. 2 is a side-perspective view of a portion of the prior art pet play area of FIG. 1, illustrating the assembly two side panels together.

FIG. 3 is a side-perspective view of the pop-up pet play area of the present invention.

FIG. 4 is a side-view of the pop-up pet play area of FIG. 3, showing the supporting spring structure.

FIG. 5 is a side-view of the pop-up pet play area of FIG. 3, showing another alternative embodiment of the supporting spring structure.

FIG. 6 is a front cross-sectional view through the pop-up pet play area of FIG. 3 with a pet within the enclosure.

FIG. 7 a side-perspective view of the pop-up pet play area of FIG. 3 being compressed.

FIG. 8 a side-perspective view of the compressed pop-up pet play area of FIG. 7 being twisted and coiled.

FIG. 9 a side-perspective view of the twisted and coiled pop-up pet play area of FIG. 8

FIG. 10 is a depiction of the effective cross-section of the compressed pop-up pet play area of FIG. 8 prior to being twisted and coiled.

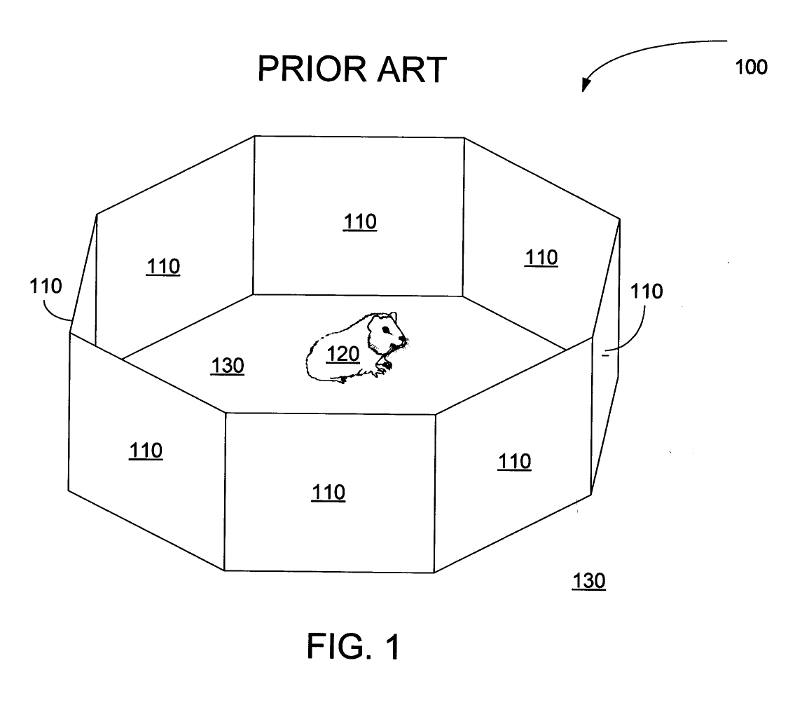

### DETAILED DESCRIPTION OF THE INVENTION

The pop-up animal play area of the present invention provides an easily set-up and stored animal play enclosure for a small animal or pet, such as a gerbil, hamster, rat, guinea pig, ferret, or the like. The enclosure provides a sidewall with an overhanging lip or awning which precludes escape of the pets out of the enclosure. The enclosure can be readily stored by compressing the structure into a flat, thin ring assembly. Moreover, the enclosure structure may be further collapsed by twisting and coiling the assembly to form a smaller diameter package.

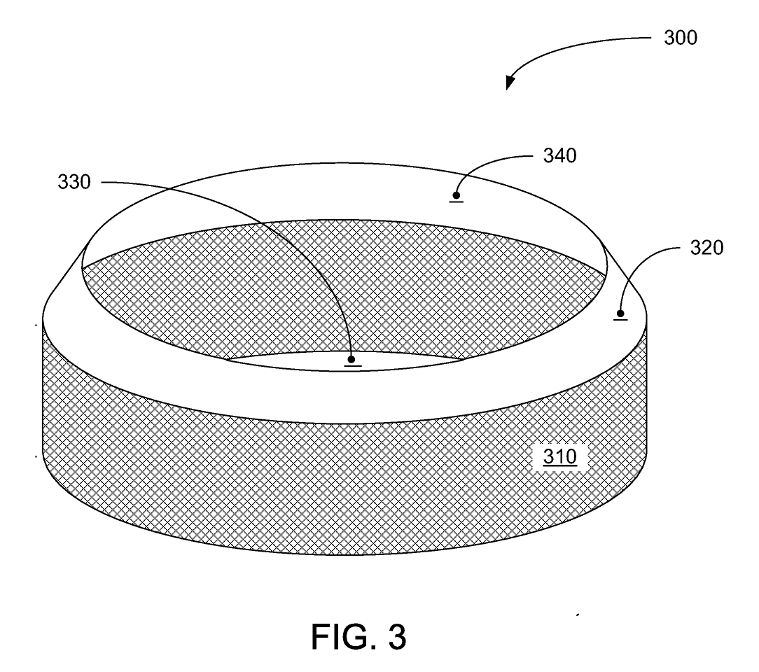

As depicted in FIG. 3, in a first embodiment the pop-up animal play enclosure 300 of the present invention is configured with a flexible textile side wall 310 forming a cylinder. In FIG. 3, the cylindrical side wall 310 is shown cross-hatched for clarity. At the base of the cylindrical side wall 310 is a flexible textile bottom 330. At the top of the cylindrical side wall 310 is a tapered cylindrical awning 320 which extends upward and tapers inward towards the center of the cylinder. Stated another way, the diameter of the cylindrical side wall 310 is relatively constant, while the diameter of the tapered awning 320 decreases as it extends upward. An animal placed within the play enclosure is constrained by the circular side wall 310. If the animal attempts to climb the side wall 310, he encounters the overhanging lower surface 340 of the awning 320 and cannot escape. An attempt to jump out of the enclosure at the side 310 will also be thwarted by the overhanging lower surface 340 of the awning 320. The flexible side wall 310, awning 320, and bottom 330 are restrained to a flexible support structure made of spring steel. The flexible support structure urges the textile of the side wall 310 and awning 320 into a taught, expanded position. The textile bottom 330 is stretched taught across the base of the flexible support structure and sewn to the side wall 310. The textile side wall 310, textile awning 320, and textile bottom 330 are sewn together using common techniques as are known in the art.

In one exemplary embodiment for small animals, the enclosure has a diameter of 36 inches, and a side wall 310 expanded height of 9 inches. The tapered awning extends 3 inches above the side wall 310 and tapers inward to a final diameter of 30 inches. This results in an enclosure 300 with a total height of 12 inches and an opening of 30 inches for viewing and interaction with the pet. Enclosures of other diameters and heights may be constructed for the range of pet sizes using the same techniques disclosed herein.

The side wall 310, awning 320, and bottom 330 of the enclosure are fabricated using 600 denier polyester. Denier polyester is a high strength, durable, scratch resistant textile which is readily available in a variety of colors. Product graphics may be applied to the polyester fabric by printing or hot transfer processes. As will be appreciated by those skilled in the art, the side wall, awning, and bottom of the enclosure 300 may be formed of any flexible and durable textile including those synthetic textiles made from polyesters, acrylics, nylons, polyurethanes, polyactides or any combination thereof. The side wall, awning, and bottom of the enclosure 300 may also be formed of natural textiles made from, cotton, wool, hemp or other plant fibres, or any combination of natural and synthetic textiles. In other alternative embodiments, a flexible plastic film or metal foil may also be used to form the enclosure side wall, awning, or bottom.

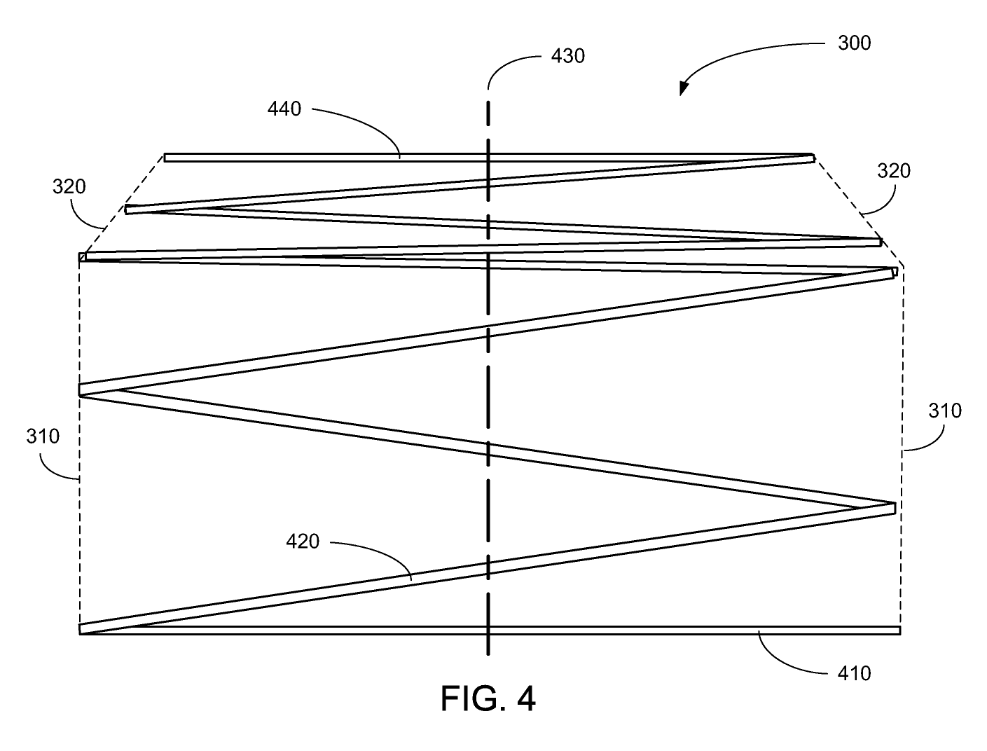

The flexible spring steel support structure of the animal play enclosure 300 is depicted in FIG. 4. In FIG. 4, the play area enclosure side wall 310 and awning 320 are depicted by dashed lines. The flexible support structure has a base hoop 410 at the base of the enclosure side wall 310. The base hoop 410 extends substantially around the periphery of the circular enclosure base. Extending upward from the base hoop 410 is a spring spar 420. The spring spar 420 wraps around the enclosure side wall 310 about a central axis depicted by centerline 430 and spirals upwards from the base hoop 410. At the top of the enclosure side wall 310, the diameter of the coil of the spring spar 420 begins to decrease as the spar spirals upward into the awning portion of the enclosure. Stated another way, the spring spar forms a constant diameter spring to the top of the enclosure side wall 310, and from the intersection of the side wall and awning forms a tapered spring to the top of the awning 320. At the top of the awning 320, the spring support structure has an awning upper hoop 440 extending substantially around the periphery of the circular awning top. The base hoop 410, spring spar 420, and awning upper hoop 440 form the flexible support structure. As used herein, the terms “flexible support structure” “spring support structure” and “support structure” are interchangeable and refer to the support structure of the animal play enclosure.

As will be appreciated by those skilled in the art, the base hoop 410, spring spar 420, and awning upper hoop 440 of the support structure may be formed by a single piece of spring steel wound with a varying diameter and pitch. The spring steel is wound to a free length longer than the combined height of the side wall 310 and awning 320. When restrained and compressed by the textile of the sidewall 310 and awning 320, the spring spar 420, base hoop 410, and awning upper hoop 440 of the support structure urges the sidewall 310 and awning 320 into a taught, expanded position. The spring spar 420 is still restrained in a partially compressed position even when the sidewall 310 and awning 320 are stretched taught. The partially compressed spring spar 420 provides a pre-load force which must be overcome before the sidewall 310 or awning 320 will begin to collapse. The spring spar is designed to achieve a pre-load force suitable for the weight of the pet of interest. With a suitable pre-load, a pet will not collapse the side wall 310 of the enclosure 300 if it attempts to climb up it. In this embodiment, the flexible support structure is a single spring having both a straight and tapered portions.

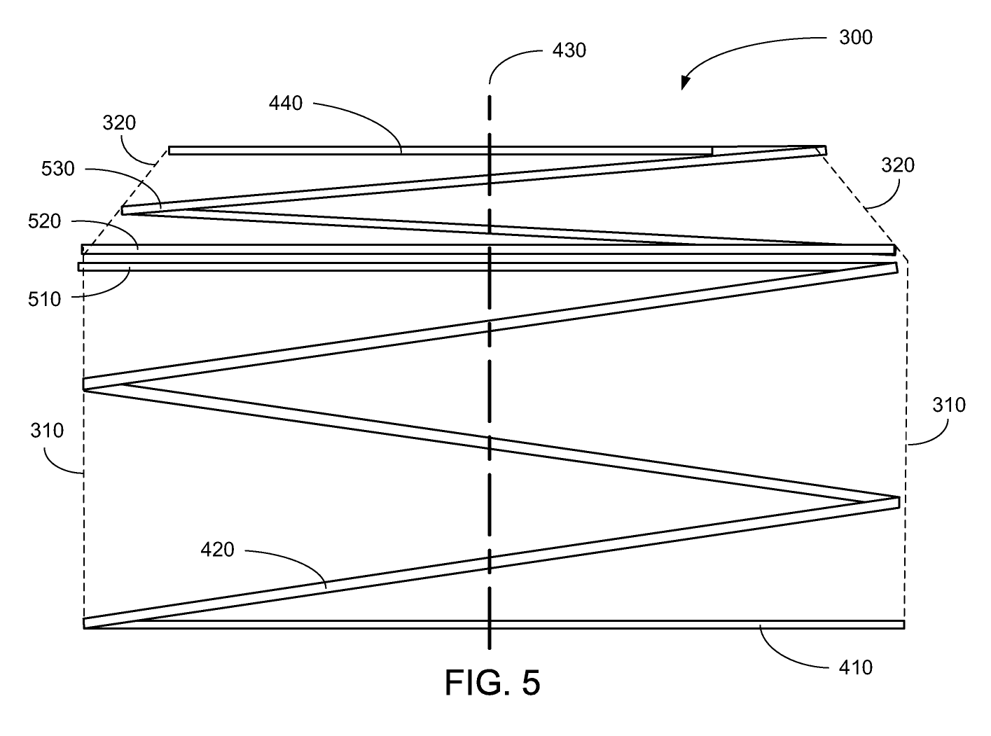

An alternative embodiment of the flexible support structure of the animal play enclosure 300 is depicted in FIG. 5. In FIG. 5, the play area enclosure side wall 310 and awning 320 are again depicted by dashed lines. In this embodiment, the steel support structure is in multiple pieces. The enclosure sidewalls 310 are supported by a base hoop 410, spring spar 420 and a sidewall upper hoop 510. The awning 320 is supported by an awning lower hoop 520, an awning spring spar 530 and an awning upper hoop 440. The spring support structure is effectively formed by a constant diameter spring and a tapered spring. The two spring components meet at the sidewall upper hoop 510 and awning lower hoop 520 and may be restrained together by ties, clasps, bonding, or by being sewn within the textile of the side wall 310 and awning 320, or any combination thereof

In the embodiments above, the material of the hoops 410, 440, 510, 520, and spring spars 420 and 530 is spring steel rod having a thin round or rectangular cross section. As may be appreciated by those skilled in the arts, other elastic materials may be used to form the support structure such as other metals and metal alloys, plastics, fiberglass or carbon rods, or other spring materials as are known to those skilled in the art.

In an alternative embodiment of the present invention, multiple spring elements extend upward from the base hoop and around the periphery of the enclosure 300. A plurality of spring spars 420 may be employed to increase the force required to compress the assembly. In this embodiment, multiple small diameter spring spars 420 are utilized to maintain a highly flexible structure while still supplying the necessary expansion force to the enclosure side walls 310 and awning 320. The spring spars are evenly spaced around the base hoop 410, and provide more distributed support to the enclosure side wall 310 and awning 320. The plurality of spring spars 420 also results in a more uniform force required to collapse the enclosure 300 into a compressed state. Each of the plurality of spring spars 420 may extend from the side wall 310 and into the awning 320 as depicted in the embodiment of FIG. 4. As in the embodiment of FIG. 5, a plurality of spring spars 420 may be employed to supply the necessary expansion force to the enclosure side walls 310. Another plurality of spring spars 530 may also be employed to increase the force required to compress the awning 320 portion of the assembly. As will be appreciated by those skilled in the art, any combination of the spring spars disclosed above may be utilized.

The spring spars may be rigidly fixed to or formed integral with the base hoop. In an alternative embodiment, the spring spars are in sliding engagement with the base hoop and may slide around the base hoop as the enclosure is compressed and folded for storage. In another alternative embodiment, the spring spars are not affixed to the base hoop and are constrained within pockets sewn within the enclosure textile walls. In yet another alternative embodiment and as similar to the spring spar 420 engagement with the base hoop 410, the spring spars may be fixed too, in sliding engagement with, or free from the awing upper hoop 440.

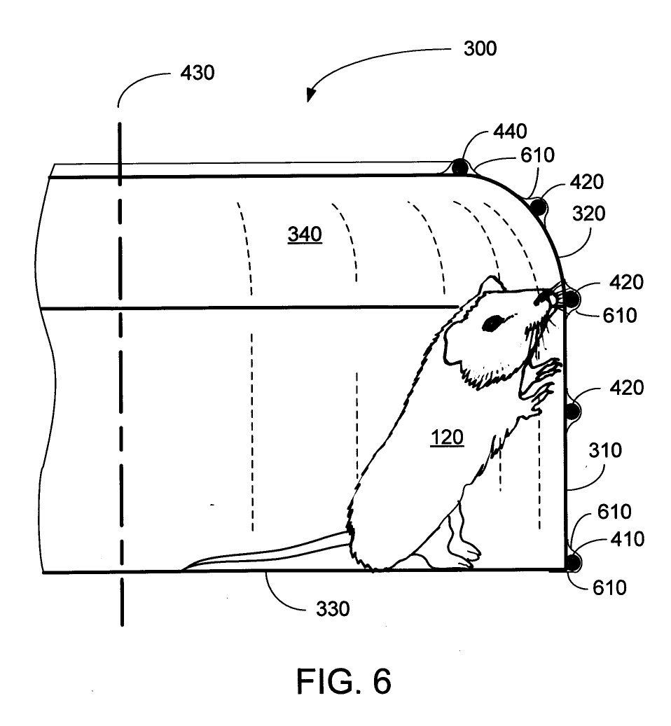

FIG. 6 is a depiction in cross-section of an animal 120 within the enclosure 300. The cross-section is taken thru the enclosure 300 central axis depicted by centerline 430. The animal 120 is supported by the textile bottom 330. The spring spar 420 is depicted as a circular cross section and is shown multiple times as it spirals around the periphery of the enclosure. The base hoop 410 and awning upper hoop 440 are also depicted in circular cross section. The base hoop 410, spring spar 420, and upper awning hoop 440 are restrained to the textile side wall 320, bottom 330, and awning 320 using textile strips 610. The textile strips 610 wrap around and sandwich the spar 420 or hoops 410, 440 adjacent to the side wall 310, bottom 330, and awning 320 respectively. The textile strips are sewn to the under-laying textile on either side of the spar 420 or hoops 410. The spar 420 and hoops 410, 440 are entrapped within the pocket formed by the textile strip 610 and under-laying side 310, awning 320, or bottom 330 textile, but are free to slide axially within the length of the pocket. This sliding restraint allows the enclosure 300 to be easily compressed and collapsed for storage, and readily expanded for set-up. The textile strip 610 is made from the same textile as the enclosure side wall 310, but may also be made of any durable textile having sufficient strength. As may be appreciated by those skilled in the art, in an alternative embodiment the spring spars and hoops may be affixed to the textile side walls using ties, clasps, adhesives, or by other means as are readily known in the art.

As also depicted in FIG. 6, the overhanging awning 320 precludes the escape of the pet 120 by climbing the sidewall 310. The inside face 340 of the awning 320 is made of flexible polyvinylchloride (“pvc”) coated nylon textile. The pvc coating results in a slippery surface which the animal may not easily climb. The pvc coating also precludes the front claws of the pet from digging into and obtaining fraction from the textile of the awning 320. Other flexible coated textiles may be used for the inside face 340 of the awning 320. The application requires a textile with a slippery surface and which resists penetration by the pets front claws. As known to those skilled in the art, other textiles coated with flexible rubber, urethane, polyester, polyvinyl, nylon, or acrylic coatings may be employed. Metal or plastic foils may also be used.

As further depicted in FIG. 6, the bottom 330 of the enclosure 300 supports the animal within the device. The bottom textile 330 is made of 600 denier polyester with a urethane water repellant coating. The urethane coated textile traps the urine and droppings of the animal 120 and is readily cleaned with soap and water. As will be appreciated by those skilled in the art, other flexible water-proof or water-repellant coated textiles may be used for the bottom panel 330 including those with flexible rubber, urethane, polyester, polyvinyl, nylon, or acrylic coatings. Metal or plastic foils may also be utilized.

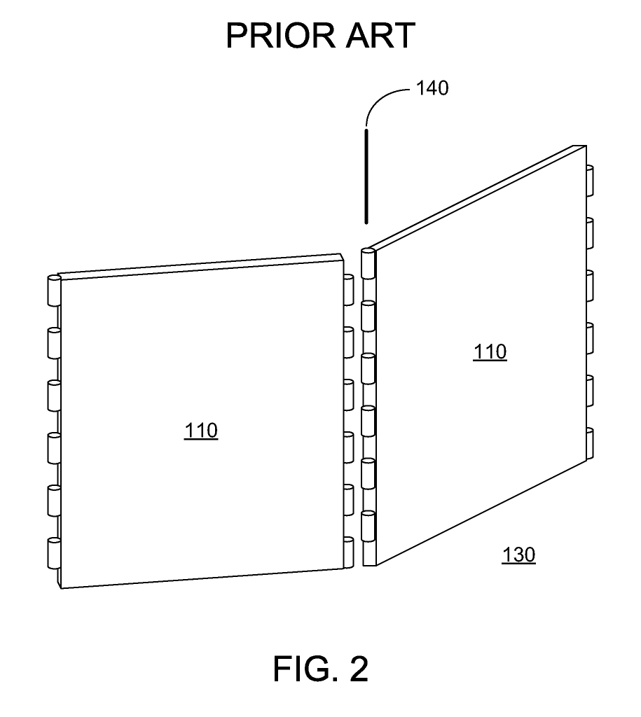

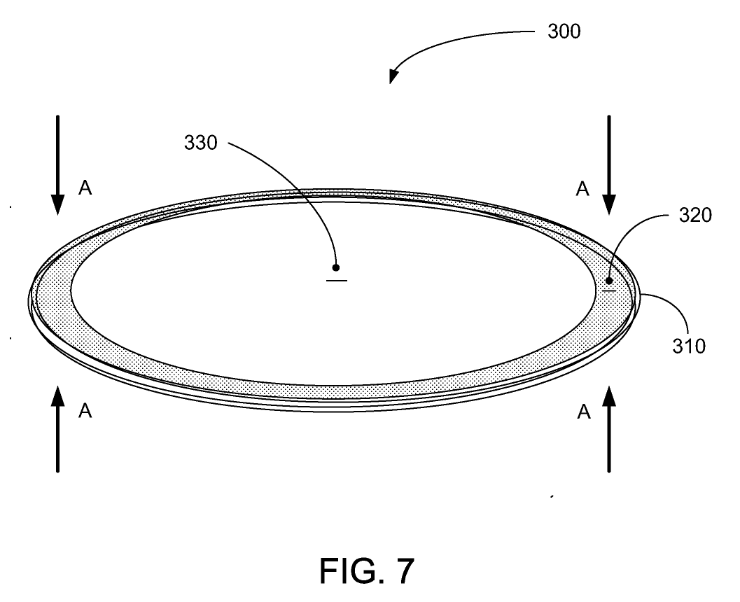

FIG. 7 depicts the compressing of the enclosure 300 for storage. Force applied in the direction of Arrow “A” compresses the enclosure 300 into a thin compact package. The expanded enclosure 300 stands approximately 12 inches tall. As depicted in FIG. 2, by compressing the internal spring structure, the enclosure may be collapsed to a total height of 1 to 2 inches. Velcro fabric restraints or ties are then used to secure the enclosure 300 in the compressed state. Upon release of the Velcro restraint, the enclosure will expand, or pop-up, and be ready to receive the pet. The time and effort required to set-up and take down the enclosure is small. This encourages both adults and children to use the device when interacting with the pet. As will be appreciated by those skilled in the art, other restraints may be used to secure the enclosure 300 in the compressed position such as clamps, clasps, or hook and loop restraints.

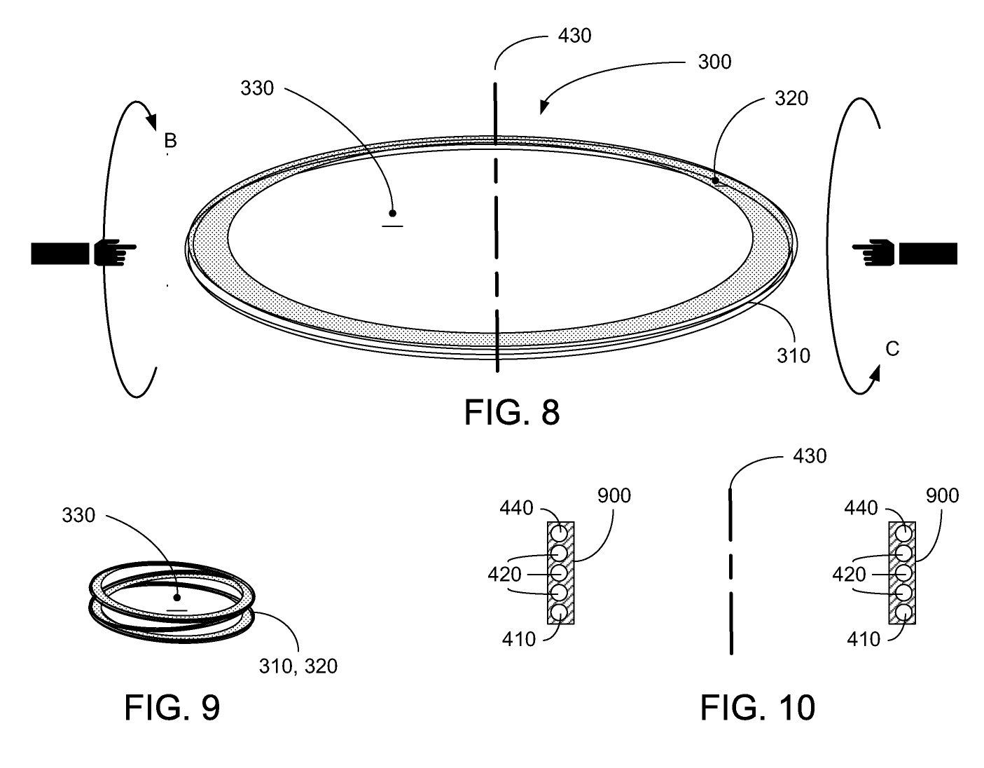

FIG. 8 depicts the further manipulation of the compressed enclosure structure of FIG. 7 for storage. To further reduce the compressed enclosure 300 size, the pet owner first grasps opposing sides of the compressed and tied enclosure. The pet owner twists opposing sides of the compressed enclosure in the opposing directions of Arrows “B” and Arrow “C”. The pet owner also brings his hands 810 together as he twists the enclosure. With manipulations, the internal spring structure of the enclosure will then collapse in upon itself to form 3 coils. In the twisted and coiled state, the textile side wall 310, awning 320, and bottom 330 will be folded about the twisted spring structure. As depicted in FIG. 9, the original enclosure 300 diameter of 36 inches is reduced to approximately 3 coils of 12 inch diameter. The twisted and coiled enclosure may then be readily stored in a bag or other packaging.

As may be appreciated by those skilled in the art, the twisting and coiling of the enclosure articulated above is similar to other elastic rings wherein the cross-sectional shape of the ring results in the ring cross-section having a substantially larger section modulus about the plane of the ring as compared to along the center axis 430 of the ring. In these structures, the section modulus about an axis passing thru the centroid of a cross-section of the ring, perpendicular to the central axis 430 is substantially larger than the sectional modulus about an axis also passing thru the centroid of a cross-section, but parallel to the central axis of the ring. A common example of such a flexible ring structure is a band-saw blade. A band-saw blade has a relatively large section modulus resulting from the width of the metal blade, the section modulus would be calculated about an axis perpendicular to the centerline 430 in FIG. 7. The thickness of the metal blade is much smaller and allows the blade to readily wrap around the wheels of the band-saw. The thin metal blade results in a relatively small section modulus as calculated about an axis parallel to the centerline 430 in FIG. 7. In shipment and storage, band-saw blades are commonly twisted and collapsed to form 3 smaller coils from the original single ring. The section modulus of the cross-section is also referred to as the moment of inertial of the cross-section and is commonly express in units of inches to the 4^{th} power.

In the same manner as a band-saw blade above, the compressed enclosure 300 of FIG. 8 has a substantially larger effective section modulus in the plane of the compressed enclosure as compared to that parallel to the center axis 430 of the ring. The compressed enclosure 320 of FIG. 8 is twisted and coiled to form a more compact package of FIG. 9. As used herein, the term “twisted and coiled” refers to the manipulation of the original compressed enclosure 300 of FIG. 8, to collapse the flexible support structure into 3 smaller diameter coils as depicted in FIG. 9.

The effective cross-section 900 of the support structure of the compressed enclosure 300 is depicted as a rectangle in FIG. 10. The effective cross-section is generated by the cross-sections of the base hoop 410, a plurality of spring spars 420, and awning hoop 440. As will be appreciated by those skilled in the art, the compressed enclosure cross-sectional depiction of FIG. 10 is idealized for demonstration and discussion. The spring spars 420, and hoops 410, 440 of the actual compressed enclosure 300 may not neatly align when compressed.

While there has been shown a preferred embodiment of the present invention, it is to be understood that certain changes may be made in the forms and arrangement of the elements of the apparatus and steps of the method for a pop-up animal play area without departing from the underlying spirit and scope of the invention.

What is claimed is:

1. A pet play enclosure for use with small pets comprising:
a textile side wall, and a spring support structure;
the textile side wall forming a cylinder having an upper edge and an opposing base edge;
the spring support structure comprising a spring element, the spring element configured to urge the textile side wall into a taught and expanded position; and
the enclosure configured to move from a first compressed position to a second expanded position upon the urging of the spring element.

2. The pet play enclosure of claim 1, further comprising:
a cylindrical textile awning, the textile awning having an awning bottom edge and an awning top edge;
the bottom edge of the textile awning being affixed to the upper edge of the textile side wall;
the spring support structure further comprising a spring element configured to urge the textile awning into a taught and expanded position; and
the textile awning configured to move from a first compressed position to a second expanded position upon the urging of the spring element.

3. The pet play enclosure of claim 2, wherein the cylindrical textile awning has a tapered diameter such that the diameter at the textile awning upper edge is less than the diameter at the textile awning lower edge.

4. The pet play enclosure of claim 1, wherein the spring element of the spring support structure comprises a spring spar in the form of a coil spring.

5. The pet play enclosure of claim 4, wherein the spring spar is constrained within pockets sewn into the textile side walls.

6. The pet play enclosure of claim 4, wherein the spring spar is constrained from fully expanding by the textile sidewall.

7. The pet play enclosure of claim 1, wherein the spring element of the spring support structure comprises a plurality of spring spars spaced about the periphery of the textile side wall.

8. The pet play enclosure of claim 7, wherein the plurality of spring spars are constrained within pockets sewn into the textile side wall.

9. The pet play enclosure of claim 7, wherein the plurality of spring spars are constrained from fully expanding by the textile sidewall.

10. The pet play enclosure of claim 2, wherein the spring element of the spring support structure comprises at least one spring spar in the form of a tapered coil spring.

11. The pet play enclosure of claim 10, wherein the at least one spring spar is constrained within pockets sewn into the textile awning.

12. The pet play enclosure of claim 10, wherein the at least one spring spar is constrained from fully expanding by the textile awning.

13. The pet play enclosure of claim 1, wherein the enclosure further comprises a textile bottom affixed across the base edge of the textile side wall.

14. The pet play enclosure of claim 2, wherein the textile awning is comprised of a polyvinylchloride coated textile.

15. The pet play enclosure of claim 1, wherein the enclosure is held in the first compressed position by a restraint and is configured to be twisted and coiled into a third collapsed position from the first compressed position.

16. The pet play enclosure of claim 2, wherein the enclosure is held in the first compressed position by a restraint and is configured to be twisted and coiled into a third collapsed position from the first compressed position.

17. The pet play enclosure of claim 2, wherein the enclosure may be held in the first compressed position by a restraint for shipping and storage, and wherein the enclosure will pop-up to the second expanded position upon release of the restraint.

18. The pet play enclosure of claim 16, wherein the enclosure may be held in the third collapsed position for shipping and storage by the storage packaging, and wherein the enclosure will return to the first compressed position upon twisting of the coils open, and wherein the enclosure will pop-up to the second expanded position upon release of the restraint.

19. A method of assembling a pet play enclosure, the pet play enclosure comprising:
a textile side wall, and a spring support structure;
the textile side wall forming a cylinder having an upper edge and an opposing base edge;
a cylindrical textile awning, the textile awning having an awning bottom edge and an awning top edge, the cylindrical textile awning having a tapered diameter such that the diameter at the textile awning upper edge is less than the diameter at the textile awning lower edge;
the bottom edge of the textile awning being affixed to the upper edge of the textile side wall;
the spring support structure comprising a spring element, the spring element configured to urge the textile side wall and textile awning from a first compressed position to a second expanded position;
wherein the enclosure is held in the first compressed position by a restraint for shipping and storage; and
the method comprising the release of the restraint, wherein the enclosure will pop-up to the second expanded position.

20. A pet play enclosure for use with small pets comprising:
a textile side wall, and a spring support structure;
the textile side wall forming a cylinder having an upper edge and an opposing base edge;
a cylindrical textile awning, the textile awning having an awning bottom edge and an awning top edge, the cylindrical textile awning having a tapered diameter such that the diameter at the textile awning upper edge is less than the diameter at the textile awning lower edge;
the bottom edge of the textile awning being affixed to the upper edge of the textile side wall;
the spring support structure comprising a spring element, the spring element configured to urge the textile side wall and textile awning into a taught and expanded position; and
the enclosure configured to move from a first compressed position to a second expanded position upon the urging of the spring element.

21. The pet play enclosure of claim 20, wherein the enclosure is configured to be twisted and coiled into a third collapsed position from the first compressed position.
